(19) United States
(12) Patent Application Publication
(10) Pub. No.: US 2026/0062201 A1
(43) Pub. Date: Mar. 5, 2026

(54) BEVERAGE OR FOODSTUFF PREPARATION SYSTEM

(71) Applicant: SOCIÉTÉ DES PRODUITS NESTLÉ S.A., Vevey (CH)

(72) Inventor: André NOTH, Pully (CH)

(21) Appl. No.: 19/108,259

(22) PCT Filed: Sep. 5, 2023
(86) PCT No.: PCT/EP2023/074288

§ 371 Date: Mar. 3, 2025

(30) Foreign Application Priority Data
Sep. 5, 2022 (EP) 22194001.8

(51) Int. Cl. B65D 85/804; A47J 31/44

(52) U.S. Cl. CPC B65D 85/8043; A47J 31/4492; B65D 2203/06

(57) ABSTRACT

A container for containing a precursor material for use with a machine for preparing a beverage and/or foodstuff or a precursor thereof, the container including a machine-readable code storing preparation information for use with a preparation process performed by said machine, the code comprising: a reference portion (R) to locate the code; a data portion (D) to store the preparation information, and; a code identifying portion (I), wherein the code identifying portion (I) is separate from the reference portion (R) and wherein code identifying portion encodes information related to a geometric arrangement of the data portion relative the reference portion.

### TECHNICAL FIELD

The present disclosure relates generally to electrically operated beverage or foodstuff preparation systems, with which a beverage or foodstuff is prepared from a pre-portioned capsule.

### BACKGROUND

Systems for the preparation of a beverage comprise a beverage preparation machine and a capsule. The capsule comprises a single-serving of a beverage forming precursor material, e.g. ground coffee or tea. The beverage preparation machine is arranged to execute a beverage preparation process on the capsule, typically by the exposure of pressurized, heated water to said precursor material. Processing of the capsule in this manner causes the at least partial extraction of the precursor material from the capsule as the beverage.

This configuration of beverage preparation machine has increased popularity due to 1) enhanced user convenience compared to a conventional beverage preparation machines (e.g. compared to a manually operated stove-top espresso maker) and 2) an enhanced beverage preparation process, wherein: preparation information encoded by a code on the capsule is read by the machine to define a recipe, and; the recipe is used by the machine to optimise the preparation process in a manner specific to the capsule. In particular, the encoded preparation information may comprise operating parameters selected in the beverage preparation process, including: fluid temperature; fluid pressure; preparation duration, and; fluid volume.

EP 2594171 A1 discloses a machine that reads a code from an underside of a flange of a capsule. A drawback of such a code is that its encoding density is limited, i.e. the amount of preparation information that it can encode is limited. A further drawback is that the code is highly visible and may be considered aesthetically displeasing. A yet further drawback is that the code may not be adapted as the machine is developed to provide enhanced user experience.

Therefore, in spite of the effort already invested in the development of said systems further improvements are desirable.

### SUMMARY

The present disclosure provides a container for containing a precursor material for use with a machine for preparing a beverage or foodstuff or a precursor thereof, the container including a machine-readable code storing preparation information for use with a preparation process performed by said machine, in which the machine is controlled based on the preparation information to prepare said beverage and/or foodstuff or precursor thereof. As used herein reference to a “code” may include one or more repetitions of the code.

In embodiments, the container includes a body portion that has a storage portion for containing the precursor material and a closing member to close the storage portion. In embodiments, the code is arranged on the closing member. In embodiments, the storage portion includes a cavity that extends in a depth direction from the closing member. The container may have a maximum depth that is less than its diameter, which can be measured at the opening of the storage portion. In embodiments, the body portion includes a flange portion that connects the storage portion to the closing member. In embodiments, the cavity of the storage portion extends in a depth direction from the flange portion. The flange portion may present a generally planar peripheral rim for receiving the closing member. In embodiments, the flange portion is planar. As used herein the term “planar” in respect of the flange portion may refer to the flange portion arranged to extend entirely with the lateral and longitudinal directions, or substantially with said directions (e.g. with major components in these directions as opposed to a depth direction). In embodiments, the container is alternatively implements as a packet.

In embodiments, the code comprises: a reference portion to locate the code; a data portion to store the preparation information, and; a code identifying portion. In embodiments, the code identifying portion encodes information related to a geometric arrangement of the data portion relative the reference portion.

By implementing a code identifying portion, the machine can read said identifying portion to identify a generation of the code and determine therefrom where and how the data portion is arranged. The data portion of the code may therefore be expanded and adapted to include different arrangements of or additional individual data portions as the machine is developed, i.e. the data portion may not be fixed in every version of the code. It will be understood that the code identifying portion is separate from the reference portion. That is, it provides a different function in encoding the organisation of the data portion, rather than being used to locate the data portion per se.

In embodiments, the machine is adapted to recognise the new generations of codes (via the information of the code identifying portion), by downloading an update via a communication interface that links the information of a new generation of code to the new encoding of the data portion, e.g. a new geometric arrangement.

As used herein the term “information related to the geometric arrangement of the data portion” may refer to information related to or be an actual spatial relationship of the data portion. The information can include an identifier that is used to look up a rule for a geometric arrangement stored on a database on the machine. The geometric arranged that is encoded can include one or more of: where it is located in the code, e.g. it's relative position with respect to the reference portion, including a start position and/or an end position; the geometric size, e.g. the absolute size from start to end; whether it is distributed as a plurality of individual data portions, and; the aforesaid for each portion.

In embodiments, the data portion at least partially encodes at least one value of a parameter of the preparation information as a geometric distance (d) of a data unit of the code along a virtual encoding line from a start position arranged on the encoding line. In embodiments, the geometric distance may be any continuous distance from the start position or as a discrete predefined position. In embodiments, an end position arranged on the encoding line defines a maximum allowable distance.

In embodiments, the geometric arrangement of the data portion related to the information encoded by code identifying portion includes a location of the start position on the encoding line. A location of the start position may be defined as one or more of: relative the reference portion; on or a distance along the encoding line from a position of intersection between the encoding line and a reference line; on or a distance along the encoding line from a position of a data unit on the encoding line.

By encoding the location of a start position on the encoding line with the code identifying portion, when processing the code it may be determined where a distance associate with encoding the value of the parameter of the data unit is measured from.

In embodiments, the geometric arrangement of the data portion related to the information encoded by code identifying portion includes a location of the end position on the encoding line. A location of the end position may be defined as one or more of: relative the reference portion; on or a distance along the encoding line from a position of intersection between the encoding line and a reference line; on or a distance along the encoding line from a position of a data unit on the encoding line.

By encoding the location of an end position on the encoding line with the code identifying portion, when processing the code it may be determined where a distance associate with encoding the value of the parameter of the data unit is measured up to, e.g. and whether the parameter encoded by the data portion has a maximum permissible value.

In embodiments, the geometric arrangement of the data portion related to the information encoded by code identifying portion includes an incremented distance and/or a number of increments between the start and end position that the data unit may be arranged within. A incremented distance may be defined as a distance of a unit that the distance between the start position and end position is organised into, in which a data unit may be positioned, e.g. for a circular distance of 90 degrees, each increment may be 5 degrees such that there are 18 units.

By encoding the increment distance and/or number of increments, when processing the code it may be determined how many possible values exist for a parameter.

By encoding one or more of the start position, end position, and increment distance, a size of a particular data portion may be increased or decreased as a priority in accuracy of an associated parameter changes.

In embodiments, the encoding line may be arranged in a predetermined position (e.g. it does not vary between versions of the code) relative the reference portion, and the code identifying portion may be read to determine where a data portion starts along the fixed encoding line. By implementing fixed position encoding lines, a computational overhead of processing a code may be reduced.

In embodiments, the data portion is arranged as a plurality of individual data portions, each arranged on the encoding line, and said geometric arrangement related to the information encoded by code identifying portion includes comprises a number of individual data portions on the encoding line. Each of the individual data portions may encode a parameter of the preparation information.

By encoding a number of individual data portions on an encoding line with the code identifying portion, the organisational arrangement of the data portions can be varied between codes, e.g. a number of parameters encoded may be increased for more sophisticated recipes.

In embodiments, there are a plurality of encoding lines and the data portion is arranged as one or more individual data portions on each of the plurality of encoding lines and the geometric arrangement encoded by the code identifying portion is related to the number of individual data portions.

By encoding the location of the individual data portions on a plurality of encoding lines with the code identifying portion, the organisational arrangement of the data portions can be varied between codes, e.g. a size of a particular data portion may be increased or decreased by moving between encoding lines as a priority in accuracy of an associated parameter changes. For embodiments, with multiple encoding lines and/or multiple individual data portions on each of the encoding lines, it will be understood that one or more of the start position, end position and increment distance/number of positions can be encoded by the information.

In embodiments, the geometric arrangement encoded by the information of the code identifying portion is related to one or more of the following arrangements of the encoding line: a number of encoding lines; a location of an encoding line (e.g. relative the reference portion); an arrangement of an encoding line (e.g. circular or straight).

By encoding said arrangement of the encoding line the location and organisation of the data portion can be encoded by the code, which may enable expansion of the code.

In embodiments, the reference portion is arranged to define a linear reference line (L), and the encoding line is circular and is arranged to intersect the reference line (L). By implementing a circular encoding line, the data portions may be compactly arranged, including with varying priority depending on the radial location of the encoding line on which they are located, e.g. a greater radial position may have greater encoding accuracy due to the greater circumferential distance.

With a circular encoding line, the geometric distance that encodes the value of a parameter of the preparation information may be: the actual distance, e.g. the circumferential distance from the start portion to the data unit; the angular distance defined by the angle between the start position and data unit; another geometric quantity related to any of the aforementioned.

In embodiments, the code identifying portion is arranged as one or more discrete positions arranged at a predefined location relative the reference portion, the discrete positions either comprising or are absent a unit to encode said information, e.g. the information related to said geometric arrangement of the data portion. The predefined location may be with respect to a radial distance from the reference portion and an angle from the reference line. In embodiments, the code identifying portion encodes the said information as binary information, e.g., with the presence of a unit encoding one of a logical 1 or a 0 and the absence of a unit encoding the other of a logical 1 or a 0. As used therein the term “binary information” may refer to information encoded as 1s and 0s.

By implementing the code identifying portion as discrete positions the accuracy of encoding may be increased as predefined values associated with said positions.

In embodiments, the code identifying portion is arranged distal the or each encoding line, e.g. with said the or each encoding line arranged between the code identifying portion and the reference portion. By arranging the code identifying portion separated from the encoding lines that the data portion is arranged on, their data may be clearly distinguished from that of the data portions.

In embodiments, the code identifying portion is arranged on the or each encoding line. By implementing the code identifying portion on an encoding line, an amount of information about the geometric arrangement of the data portion may be increased.

In embodiments, the code identifying portion encodes information related to a representation of a data unit. As used herein the term “representation of a data unit” may refer to one or more of: a shape of a unit, e.g. a peripheral shape including square or circular; a size of a unit, e.g. a diameter; whether an encoding distance is defined by one or several units, e.g. a data unit may comprise two individual units, with an effective coordinate of the data unit (i.e. the associated encoding distance) being a mid-point therebetween.

By implementing the code identifying portion to encode a representation of a data unit, greater expansion of the code may be implemented as the machine is developed.

In embodiments, the code identifying portion encodes information related to an encoding of the data unit being continuous or discrete on the encoding line. By implementing the code identifying portion to encode whether the data unit can be arranged along the encoding line at any continuous position from the start position or at only discrete positions therefrom, greater expansion of the code may be implemented as the machine is developed.

In embodiments, the code identifying portion encodes information related to a type of data encoded by the data portion. By implementing the code identifying portion to encode what the parameter is, greater expansion of the code may be implemented as the machine is developed.

In embodiments, the code identifying portion encodes information related to a rule for decoding the encoded preparation information. By implementing the code identifying portion to encode a rule for decoding a parameter, greater expansion of the code may be implemented as the machine is developed.

As used herein the term rule may refer to a relationship between the encoding distance and the value of the parameter. In particular it may refer to a numerical equation rather than parameters for input into the number equation. For example, the rule may be whether the relationship is linear or non-linear rather than just parameters defining the linearity.

In embodiments, the information encoded by the code identifying portion comprises an identifier, which is for use by said machine to look-up said geometric arrangement of the data portion. By implementing the information as a key, the specific geometric arrangement can be looked up using a key value database paradigm. The identifier may be encoded as binary information.

The present disclosure provides a substrate for attachment to: a container for containing a precursor material for use with a machine for preparing a beverage and/or foodstuff or a precursor thereof, or; for attachment to a machine for preparing a beverage and/or foodstuff. The substrate comprising a code comprising any feature of the code of the preceding embodiments or another embodiment disclosed herein.

As used herein the term “substrate” may refer to any suitable carrier for the code that can be used to connect the code to a container or the machine, examples of which include: a sticker; a cardboard member to receive an adhesive strip, and; other suitable arrangements.

The present disclosure provides a code for a container for containing a precursor material for use with a machine for preparing a beverage and/or foodstuff or a precursor thereof, the container including a machine-readable code storing preparation information for use with a preparation process performed by said machine, the code comprising: a reference portion (R) to locate the code; a data portion (D) to store the preparation information, and; a code identifying portion (I), wherein the code identifying portion (I) is separate from the reference portion (R) and wherein the code identifying portion encodes information related to a geometric arrangement of the data portion relative the reference portion. The code may comprise any feature of the code of the preceding embodiments, or another embodiment disclosed herein. The code may be arranged on a substrate for attachment to: a container as defined herein, or; a machine as defined herein, or; or other component, e.g. including a hand held component that is arranged for a user to present to a code reader of the machine. The code may be formed on a closing member of the container.

The present disclosure provides a machine for preparing a beverage and/or foodstuff or a precursor thereof from the container of any preceding embodiment or another embodiment disclosed herein.

In embodiments, the machine comprises: a code reading system to read a code of a container; a processing unit for processing precursor material of the container, and; electrical circuitry to control the processing unit based on preparation information read from the code.

As used herein the term “based on” in respect of the preparation information may refer to a direct relationship (e.g. a value of a parameter of a recipe is encoded directly on the code) or a rule is used via a stored relationship to look up one or more of said values using the preparation information as an identifier. The code reader may include an image capturing unit (e.g. a camera) a lens and an outermost aperture (e.g. a reading window). An outermost portion of the code reader may be referred to as a reading head.

In embodiments, the processing unit includes a container processing unit and a fluid processing system, and; the electrical circuitry is arranged to control the container processing unit and fluid processing system based on the preparation information read from the code.

In embodiments, the processing unit is arranged as a loose material processing unit, and; the electrical circuitry is arranged to control the loose material processing unit to process loose precursor material dispensed from the container or arranged in the container based on the preparation information read from the code.

In embodiments, the electrical circuitry of the machine implements a method of reading preparation information from a code as disclosed herein.

In embodiments, the electrical circuitry implements electronic memory relating a stored relationship between the information encoded by the code identifying portion to one or more of: a geometric arrangement of a data portion of the code; a representation of a data unit, wherein said representation comprises whether an encoding distance is defined by one or more data units; an encoding of the data unit being continuous or at discrete positions on the encoding line; a type of data encoded by the data portion, and; a rule for decoding the encoded preparation information.

The present disclosure provides a system comprising the container of any preceding embodiment or another embodiment disclosed herein and a machine for preparing a beverage and/or foodstuff or a precursor thereof according to any preceding embodiment or another embodiment disclosed herein.

The present disclosure provides use of the container of any preceding embodiment or another embodiment disclosed herein for a machine for preparing a beverage and/or foodstuff or a precursor thereof according to any preceding embodiment or another embodiment disclosed herein.

The present disclosure provides a method of encoding preparation information with a code, which may be arranged on a container. The method may implement the features of any preceding embodiment or another embodiment disclosed herein.

In embodiments, the method comprises: arranging a data portion of the code relative to a reference portion.

In embodiments, the method comprises arranging a geometric arrangement of the data portion based on information encoded by a code identification portion of the code.

In embodiments, the method comprises representing a data unit, wherein said representation comprises whether an encoding distance is defined by one or more data units, based on information encoded by a code identification portion of the code.

In embodiments, the method comprises encoding a data unit with continuous or at discrete positions on an encoding line based on information encoded by a code identification portion of the code.

In embodiments, the method comprises relating a type of data encoded by the data portion based on information encoded by a code identification portion of the code.

The present disclosure provides a method of reading preparation information from a code for use in a preparation process, in which a machine is controlled based on the preparation information to prepare a beverage and/or foodstuff or precursor thereof. The method may implement the features of any preceding embodiment, or another embodiment disclosed herein.

In embodiments, the method comprises: locating a reference portion (R) of the code, and; reading the data portion based on the determine location of the reference portion (R) to determine the preparation information from the data portion (D).

In embodiments, the method comprises: reading a code identifying portion (1) of the code arranged relative the located reference portion.

In embodiments, the method comprises: reading a code identifying portion (1) of the code to determine one or more of: a geometric arrangement of a data portion (D); a representation of a data unit, wherein said representation comprises whether an encoding distance is defined by one or more data units; an encoding of the data unit being continuous or at discrete positions on the encoding line; a type of data encoded by the data portion, and; a rule for decoding the encoded preparation information.

In embodiments, the method comprises: obtaining information from the code identifying portion, and; and determining one or more of the aforesaid items based on a stored (e.g. in electronic memory of the machine) relationship (e.g. as a key value database paradigm) between the information and the item.

In embodiments, the method comprises: reading the data portion (D) based on one or more of: the determined geometric arrangement of a data portion (D); the determined representation of the data unit, wherein said representation comprises whether an encoding distance is defined by one or more data units; the determined encoding of the data unit being continuous or at discrete positions on the encoding line; the determined type of data encoded by the data portion, and; the determined rule for decoding the encoded preparation information.

The method may be implemented as part of a method of preparing a beverage or foodstuff or a precursor thereof, in which a processing unit is controlled based on the preparation information to execute a preparation process on the precursor material.

The present disclosure provides electrical circuitry to implement the method of the preceding embodiments or another embodiment disclosed herein.

The present disclosure provides a computer readable medium comprising program code, which may be executable on one or more processors, to implement the method of the preceding embodiments or another embodiment disclosed herein.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments.

Other features, aspects, and advantages of the subject matter described herein will become apparent from the following Detailed Description of Embodiments, Brief Description of Figures, and Claims.

### BRIEF DESCRIPTION OF FIGURES

Aspects, features and advantages of embodiments of the present disclosure will become apparent from the following detailed description of embodiments in reference to the appended drawings in which like numerals denote like elements.

FIG. 1 is a block system diagram showing an embodiment system for preparation of a beverage or foodstuff.

FIG. 2 is a block system diagram showing an embodiment machine of the system of FIG. 1.

FIG. 3 is an illustrative diagram showing an embodiment fluid conditioning system of the machine of FIG. 2.

FIGS. 4 and 5 are illustrative diagrams showing an embodiment container processing system of the machine of FIG. 2 on open and closed positions.

FIG. 6 is an illustrative diagram showing an embodiment machine of FIG. 2, which comprises a loose material processing unit.

FIG. 7 is a block diagram showing embodiment control electrical circuitry of the machine of FIG. 2.

FIGS. 8 and 9 are illustrative diagrams showing embodiment containers of the system of FIG. 1.

FIG. 10 is flow diagram showing an embodiment preparation process, which is performed by the system of FIG. 1.

FIG. 11 is a plan view showing an embodiment code of the containers of the system of FIG. 1.

FIGS. 12 and 13 are flow diagrams showing embodiment processes for extracting preparation information from the code of FIG. 11.

FIGS. 14 to 16 are plan views showing embodiments of the code of FIG. 11.

FIG. 17 is a flow diagram showing embodiment processes for extracting preparation information from the various example codes.

### DETAILED DESCRIPTION OF EMBODIMENTS

Before describing several embodiments of the system, it is to be understood that the system is not limited to the details of construction or process steps set forth in the following description. It will be apparent to those skilled in the art having the benefit of the present disclosure that the system is capable of other embodiments and of being practiced or being carried out in various ways.

The present disclosure may be better understood in view of the following explanations:

As used herein, the term “machine” may refer to an electrically operated device that: can prepare, from a precursor material, a beverage and/or foodstuff, or; can prepare, from a pre-precursor material, a precursor material that can be subsequently prepared into a beverage and/or foodstuff. The machine may implement said preparation by one or more of the following processes: dilution; heating; cooling; mixing; whisking; dissolution; soaking; steeping; extraction; conditioning; infusion; grinding, and; other like process. The machine may be dimensioned for use on a work top, e.g. it may be less than 70 cm in length, width and height. As used herein, the term “prepare” in respect of a beverage and/or foodstuff may refer to the preparation of at least part of the beverage and/or foodstuff (e.g. a beverage is prepared by said machine in its entirety or part prepared to which the end-user may manually add extra fluid prior to consumption, including milk and/or water).

As used herein, the term “container” may refer to any configuration to contain the precursor material, e.g. as a single-serving, pre-portioned amount. The container may have a maximum capacity such that it can only contain a single-serving of precursor material. The container may be single use, e.g. it is physically altered after a preparation process, which can include one or more of: perforation to supply fluid to the precursor material; perforation to supply the beverage/foodstuff from the container; opening by a user to extract the precursor material. The container may be configured for operation with a container processing unit of the machine, e.g. it may include a flange for alignment and directing the container through or arrangement on said unit. The container may include a rupturing portion, which is arranged to rupture when subject to a particular pressure to deliver the beverage/foodstuff. The container may have a membrane for closing the container. The container may have various forms, including one or more of: frustoconical; cylindrical; disk; hemispherical; packet; other like form. The container may be formed from various materials, such as metal or plastic or paper or a combination thereof. The material may be selected such that it is one or more of: food-safe; it can withstand the pressure and/or temperature of a preparation process, and; it is biodegradable. The container may be defined as a capsule, wherein a capsule may have an internal volume of 20-100 ml. The capsule includes a coffee capsule, e.g. a Nespresso® or Nescafé® capsule (including a Classic, Professional, Vertuo, Dolce Gusto or other capsule). The container may be defined as a receptacle, wherein a receptacle may have an internal volume of 150-350 ml. The receptacle is typically for end user consumption therefrom, and includes a pot, for consumption via an implement including a spoon, and a cup for drinking from. The container may be defined as a packet, wherein the packet is formed from a flexible material, including plastic or foil. A packet may have an internal volume of 150-350 ml or 200-300 ml or 50-150 ml.

As used herein, the term “external device” or “external electronic device” or “peripheral device” may include electronic components external to the machine, e.g. those arranged at a same location as the machine or those remote from the machine, which communicate with the machine over a computer network. The external device may comprise a communication interface for communication with the machine and/or a server system. The external device may comprise devices including: a smartphone; a PDA; a video game controller; a tablet; a laptop; or other like device.

As used herein, the term “server system” may refer to electronic components external to the machine, e.g. those arranged at a remote location from the machine, which communicate with the machine over a computer network. The server system may comprise a communication interface for communication with the machine and/or the external device. The server system can include: a networked-based computer (e.g. a remote server); a cloud-based computer; any other server system.

As used herein, the term “system” or “beverage or foodstuff preparation system” may refer to the combination of any two of more of: the beverage or foodstuff preparation machine; the container; the server system, and; the peripheral device.

As used herein, the term “beverage” may refer to any substance capable of being processed to a potable substance, which may be chilled or hot. The beverage may be one or more of: a solid (e.g. a solid suspended in a liquid); a liquid; a gel; a paste. The beverage may include one or a combination of: tea; coffee; hot chocolate; milk; cordial; vitamin composition; herbal tea/infusion; infused/flavoured water, and; other substance. As used herein, the term “foodstuff” may refer to any substance capable of being processed to a nutriment for eating, which may be chilled or hot. The foodstuff may be one or more of: a solid; a liquid; a gel; a paste. The foodstuff may include: yoghurt; mousse; parfait; soup; ice cream; sorbet; custard; smoothies; other substance. It will be appreciated that there is a degree of overlap between the definitions of a beverage and foodstuff, e.g. a beverage can also be a foodstuff and thus a machine that is said to prepare a beverage or foodstuff does not preclude the preparation of both.

As used herein, the term “precursor material” may refer to any material capable of being processed to form part or all of the beverage or foodstuff. The precursor material can be one or more of a: powder; crystalline; liquid; gel; solid, and; other. Examples of a beverage forming precursor material include: ground coffee; milk powder; tea leaves; coco powder; vitamin composition; herbs, e.g. for forming a herbal/infusion tea; a flavouring, and; other like material. Examples of a foodstuff forming precursor material include: dried vegetables or stock as anhydrous soup powder; powdered milk; flour based powders including custard; powdered yoghurt or ice-cream, and; other like material. A precursor material may also refer to any pre-precursor material capable of being processed to a precursor material as defined above, i.e. any precursor material that can subsequently be processed to a beverage and/or foodstuff. In an example, the pre-precursor material includes coffee beans which can be ground and/or heated (e.g. roasted) to the precursor material.

A precursor material may also refer to any pre-precursor material capable of being processed to a precursor material as defined above, i.e. any precursor material that can subsequently be processed to a beverage and/or foodstuff. In an example, the pre-precursor material includes coffee beans which can be ground and/or heated (e.g. roasted) to the precursor material.

As used herein, the term “fluid” (in respect of fluid supplied by a fluid conditioning system) may include one or more of: water; milk; other. As used herein, the term “conditioning” in respect of a fluid may refer to to change a physical property thereof and can include one or more of the following: heating or cooling; agitation (including frothing via whipping to introduce bubbles and mixing to introduce turbulence); portioning to a single-serving amount suitable for use with a single serving container; pressurisation e.g. to a brewing pressure; carbonating; fliting/purifying, and; other conditioning process.

As used herein, the term “processing unit” may refer to an arrangement that can process precursor material to a beverage or foodstuff. It may refer to an arrangement that can process a pre-precursor material to a precursor material.

As used herein, the term “container processing unit” may refer to an arrangement that can process a container to derive an associated beverage or foodstuff from a precursor material. The container processing unit may be arranged to process the precursor material by one of more of the following: dilution; heating; cooling; mixing; whisking; dissolution; soaking; steeping; extraction; conditioning; pressurisation; infusion, and: other processing step. The container processing unit may therefore implement a range of units depending on the processing step, which can include: an extraction unit (which may implement a pressurised and/or a thermal, e.g. heating or cooling, brewing process); a mixing unit (which mixes a beverage or foodstuff in a receptacle for end user consumption therefore; a dispensing and dissolution unit (which extracts a portion of the precursor material from a repository, processes by dissolution and dispenses it into a receptacle), and: other like unit.

As used herein, the term “loose material processing unit” may refer to an arrangement that can process loose material of a pre-precursor material to a precursor material. The loose material processing unit may be arranged to process the pre-precursor material by one of more of the following: heating; cooling; grinding; mixing; soaking; conditioning; other processing step. The loose material may be supplied to the loose material processing unit in a container, from which it is extracted and processed.

As used herein, the term “preparation process” may refer to a process to prepare a beverage or foodstuff from a precursor material or to prepare a pre-precursor material from precursor material. A preparation process may refer to the processes electrical circuitry executes to control the container processing unit to process said precursor or pre-precursor material.

As used herein, the term “electrical circuitry” or “circuitry” or “control electrical circuitry” may refer to one or more hardware and/or software components, examples of which may include: an Application Specific Integrated Circuit (ASIC); electronic/electrical componentry (which may include combinations of transistors, resistors, capacitors, inductors etc); one or more processors; a non-transitory memory (e.g. implemented by one or more memory devices), that may store one or more software or firmware programs; a combinational logic circuit; interconnection of the aforesaid. The electrical circuitry may be located entirely at the machine, or distributed between one or more of: the machine; external devices; a server system.

As used herein, the term “processor” or “processing resource” may refer to one or more units for processing, examples of which include an ASIC, microcontroller, FPGA, microprocessor, digital signal processor (DSP), state machine or other suitable component. A processor may be configured to execute a computer program, e.g. which may take the form of machine readable instructions, which may be stored on a non-transitory memory and/or programmable logic. The processor may have various arrangements corresponding to those discussed for the circuitry, e.g. on-board machine or distributed as part of the system. As used herein, any machine executable instructions, or computer readable media, may be configured to cause a disclosed method to be carried out, e.g. by the machine or system as disclosed herein, and may therefore be used synonymously with the term method, or each other.

As used herein, the term “computer readable medium/media” or “data storage” may include any medium capable of storing a computer program, and may take the form of any conventional non-transitory memory, for example one or more of: random access memory (RAM); a CD; a hard drive; a solid state drive; a memory card; a DVD. The memory may have various arrangements corresponding to those discussed for the circuitry.

As used herein, the term “communication resources” or “communication interface” may refer to hardware and/or firmware for electronic information transfer. The communication resources/interface may be configured for wired communication (“wired communication resources/interface”) or wireless communication (“wireless communication resources/interface”). Wireless communication resources may include hardware to transmit and receive signals by radio and may include various protocol implementations e.g. the 802.11 standard described in the Institute of Electronics Engineers (IEEE) and Bluetooth™ from the Bluetooth Special Interest Group of Kirkland Wash. Wired communication resources may include; Universal Serial Bus (USB); High-Definition Multimedia Interface (HDMI) or other protocol implementations. The machine may include communication resources for wired or wireless communication with an external device and/or server system.

As used herein, the term “network” or “computer network” may refer to a system for electronic information transfer between a plurality of apparatuses/devices. The network may, for example, include one or more networks of any type, which may include: a Public Land Mobile Network (PLMN); a telephone network (e.g. a Public Switched Telephone Network (PSTN) and/or a wireless network); a local area network (LAN); a metropolitan area network (MAN); a wide area network (WAN); an Internet Protocol Multimedia Subsystem (IMS) network; a private network; the Internet; an intranet.

As used herein, the term “code” may refer to a storage medium that encodes preparation information. The code may be an optically readable code, e.g. a bar code. The code may be arranged as a bit code (e.g. a binary sequence of 0s and 1s encoded by the absence or presence of an element). The code may be formed of a plurality of units, which can be referred to as elements or markers. The elements may implement a finder portion and a data portion, wherein the finder portion encodes a predefined reserved string of bits that is identifiable when processing the code from the data portion, to enable location of the data portion, which encodes the preparation information. The code may be arranged as a one dimensional code, which is read by relative movement between the code and a code reader. The code reader may provide a bit stream signal or a high and low signal for processing by preparation information extraction. The code may be arranged as a two dimensional code, which is processed via a digital image obtained from a camera of the code reader. It will be understood that a code may therefore exclude a mere surface finish or branding on a container, which is not configured in any way for information storage.

As used herein the term “preparation information” may refer to one of more of: parameters as defined herein; a recipe as defined herein; an identifier, and; other information related to the operation of the machine.

As used herein, the term “parameter” may refer to a variable that is used as an input for controlling (e.g. RPM) and/or or a property of the beverage/foodstuff or a precursor thereof that is controlled by the processing unit (e.g. a fluid target temperature or volume) during the preparation process. Depending on the implementation of the processing unit said parameter may vary. Examples include: volume of a particular component of the beverage and/or foodstuff; fluid temperature; fluid flow rate; operational parameters of the processing unit, e.g. RPM of an extraction unit based on centrifugation or closing force for a hydraulic brewing unit; an order of dispensing of components of the beverage and/or foodstuff; agitation (e.g. frothing degree); any of the aforesaid defined for one or more phases, wherein the preparation process is composed of a series of sequential, discrete phases. The parameters that may be associated container processing unit that comprises a loose material processing unit, can include one or more of: grinding parameters, including intensity; heating temperature. The parameter may have a value, which may be numerical and can vary in predetermined increments between predetermined limits, e.g. a temperature of the water may vary between 60-90 degrees in 5 degree increments.

As used herein, the term “recipe” or “control data set” may refer to a combination of said parameters, e.g. as a full or partial set of inputs, that are used by the processing unit to prepare a particular beverage and/or food stuff.

As used herein, the term “preparation process” may refer to a process to prepare a beverage or foodstuff from a precursor material or to prepare a pre-precursor material from precursor material. A preparation process may refer to the processes electrical circuitry executes to control the processing unit to process said precursor or pre-precursor material.

As used herein, the term “code reading process” may refer to the process of reading the code to extract the preparation information (which can include the identifier and/or parameters). The process may include one or more of the following steps: obtaining a digital image of the code or a code signal; extracting a sequence of bits from the code; identifying a finder portion of the code in the sequence; locating a data portion using the finder portion, and; extracting the preparation information from the data portion.

### [General System Description]

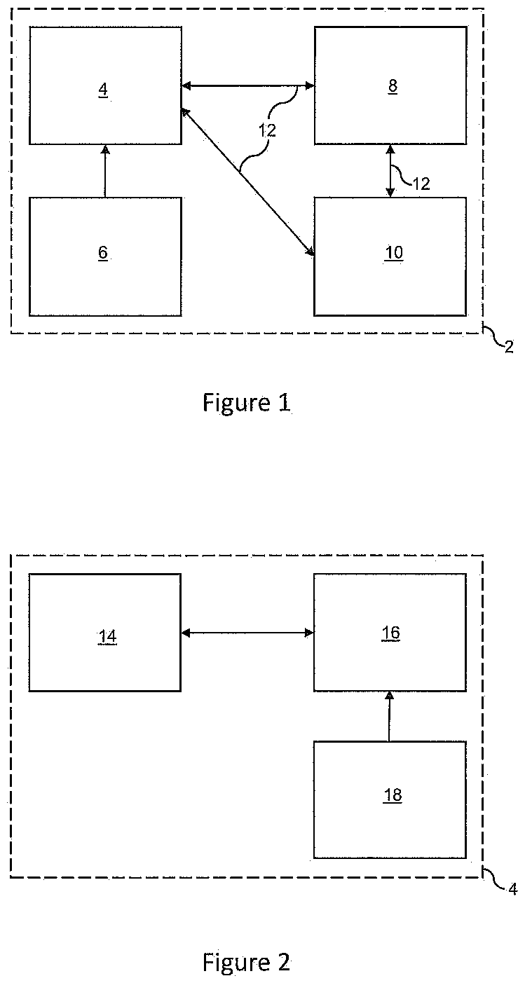

Referring to FIG. 1, the system 2 comprises a machine 4, a container 6, server system 8 and a peripheral device 10. The server system 8 is in communication with the machine 4 via a computer network 12. The peripheral device 10 is in communication with the machine 4 via the computer network 12.

In variant embodiments, which are not illustrated: the peripheral device and/or server system is omitted.

Although the computer network 12 is illustrated as the same between the machine 4, server system 8 and peripheral device 10, other configurations are possible, including: a different computer network for intercommunication between each device: the server system communicates with the machine via the peripheral device rather than directly. In a particular example: the peripheral device communicates with the machine via a wireless interface, e.g. with a Bluetooth™ protocol, and; the server system communicates with the machine via a via a wireless interface, e.g. with a IEE 802.11 standard, and also via the internet.

### [Machine]

Referring to FIG. 2, the machine 4 comprises: a processing unit 14 for processing the precursor material; electrical circuitry 16, and; a code reading system 18.

The electrical circuitry 16 controls the code reading system 18 to read a code (not illustrated in FIG. 2) from the container 6 and determine preparation information therefrom. The electrical circuitry 16 uses the preparation information to control the processing unit 14 to execute a preparation process, in which the precursor material is process to a beverage or foodstuff or a precursor thereof.

### First Example of Processing Unit

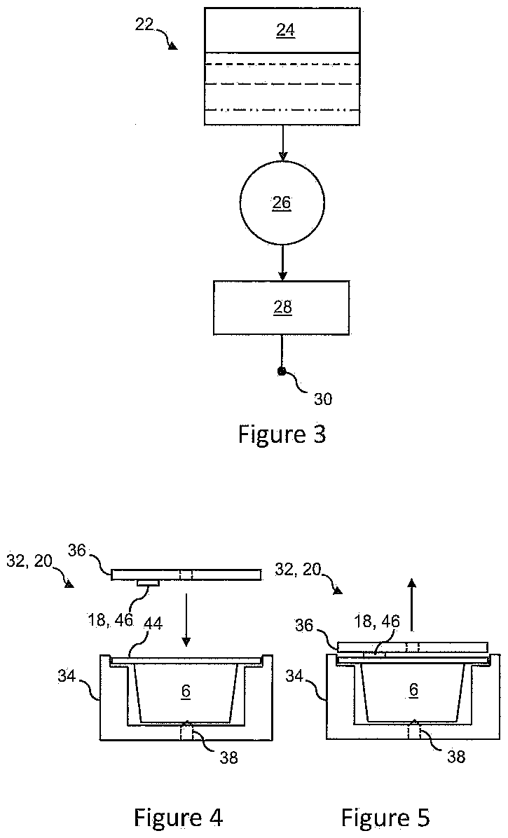

Referring to FIGS. 3, 4 and 5, in a first example of the processing unit 14, said unit comprises a container processing unit 20 and a fluid conditioning system 22.

The container processing unit 20 is arranged to process the container 6 to derive a beverage or foodstuff from precursor material (not illustrated) therein. The fluid conditioning system 22 conditions fluid supplied to the container processing unit 20. The electrical circuitry 16 uses the preparation information read from the container 6 to control the container processing unit 20 and the fluid conditioning system 22 to execute the preparation process.

### [Fluid Conditioning System]

Referring to FIG. 3, the fluid conditioning system 22 includes a reservoir 24; pump 26; heat exchanger 28, and; an outlet 30 for the conditioned fluid. The reservoir 24 contains fluid, typically sufficient for multiple preparation processes. The pump 26 displaces fluid from the reservoir 24, through the heat exchanger 26 and to the outlet 30 (which is connected to the container processing unit 20). The pump 26 can be implement as any suitable device to drive fluid, including: a reciprocating; a rotary pump; other suitable arrangement. The heat exchanger 28 is implemented to heat the fluid, and can include: an in-line, thermo block type heater; a heating element to heat the fluid directly in the reservoir; other suitable arrangement.

In variant embodiments, which are not illustrated: the pump is omitted, e.g. the fluid is fed by gravity to the container processing unit or is pressurised by a mains water supply; the reservoir is omitted, e.g. water is supplied by a mains water supply; the heat exchanger is arranged to cool the fluid, e.g. it may include a refrigeration-type cycle heat pump; the heat exchanger is omitted, e.g. a mains water supply supplies the water at the desired temperature; the fluid conditioning system includes a filtering/purification system, e.g. a UV light system, a degree of which that is applied to the fluid is controllable; a carbonation system that controls a degree to which the fluid is carbonated.

### [Container Processing Unit]

The container processing unit 20 can be implemented with a range of configurations, as illustrated in examples 1-6 below. Generally, in examples where the machine 2 comprises a guide portion, in to which a container is inserted and is guided by gravity (e.g. under its own weight) to the container processing unit 20, the container processing unit 20 is arranged with a container holding portion and a closing portion, which are movable between a container receiving position and a container processing position in a depth direction, which is perpendicular (including substantially perpendicular) to a direction of transmission of the guide portion.

Referring to FIGS. 4 and 5, a first example of the container processing unit 20 is for processing of a container arranged as a capsule 6 (a suitable example of a capsule is provided in FIG. 7, which will be discussed) to prepare a beverage. The container processing unit 20 is configured as an extraction unit 32 to extract the beverage from the capsule 6. The extraction unit 32 includes a capsule holding portion 34 and a closing portion 36. The extraction unit 32 is movable to a capsule receiving position (FIG. 4), in which capsule holding portion 34 and a closing portion 36 are arrange to receive a capsule 6 therebetween. The extraction unit 32 is movable to a capsule extraction position (FIG. 5), in which the capsule holding portion 34 and a closing portion 36 form a seal around a capsule 6, and the beverage can be extracted from the capsule 6. The extraction unit 32 can be actuator driven or manually movable between said positions.

The outlet 30 of the fluid conditioning system 22 is arranged as an injection head 38 on the capsule holding portion 34 to inject the conditioned fluid into the capsule 6 in the capsule extraction position, typically under high pressure. A beverage outlet 40 on the closing portion 36 is arranged to capture the extracted beverage and convey it from the extraction unit 32.

The extraction unit 32 is arranged to prepare a beverage by the application of pressurised (e.g. at 10-20 Bar), heated (e.g. at 50-98 degrees C.) fluid to the precursor material within the capsule 6. The pressure is increased over a predetermined amount of time until a pressure of a rupturing portion (not illustrated in FIGS. 4 and 5) of the capsule 6 is exceeded, which causes rupture of said portion and the beverage to be dispensed to the beverage outlet 40.

In variant embodiments, which are not illustrated, although the injection head and beverage outlet are illustrated as arranged respectively on the capsule holding portion and closing portion, they may be alternatively arranged, including: the injection head and beverage outlet are arranged respectively on the closing portion capsule holding portion and; or both on the same portion. Moreover, the extraction unit may include both parts arranged as a capsule holding portion, e.g. for capsules that are symmetrical about the flange, including a Nespresso® Professional capsule. Examples of suitable extraction units are provided in EP 1472156 A1 and in EP 1784344 A1 and provide a hydraulically sealed extraction unit.

In a second example (which is not illustrated) of the container processing unit a similar extraction unit to the first example is provided, however the extraction unit operates at a lower pressure and by centrifugation. An example of a suitable capsule is a Nespresso® Vertuo capsule. A suitable example is provided in EP 2594171 A1. With such an example (or indeed the other examples) a guide portion may be obviated and the container manually loaded into the extraction unit.

In a third example, (which is not illustrated) the capsule processing unit operates by dissolution of a beverage precursor that is selected to dissolve under high pressure and temperature fluid. The arrangement is similar to the extraction unit of the first and second example, however the pressure is lower and therefore a sealed extraction unit is not required. In particular, fluid can be injected into a lid of the capsule and a rupturing portion is located in a base of a storage portion of the capsule. An example of a suitable capsule is a or Nescafé® Dolce Gusto capsule. Examples of suitable extraction units are disclosed in EP 1472156 A1 and in EP 1784344 A1.

In a fourth example, (which is not illustrated) wherein the container is arranged as a packet, the container processing unit implements an extraction unit operable to receive the packet and to inject, at an inlet thereof, fluid from the fluid conditioning system. The injected fluid mixes with precursor material within the packet to at least partially prepare the beverage, which exits the packet via an outlet thereof. An example of such an arrangement is provided in WO2014125123 A1 or in WO2022023578A1.

In a fifth example, (which is not illustrated) the container processing unit is arranged as a mixing unit to prepare a beverage or foodstuff precursor that is stored in a container that is a receptacle, which is for end user consumption therefrom. The mixing unit comprises an agitator (e.g. planetary mixer; spiral mixer; vertical cut mixer) to mix and a heat exchanger to heat/cool the beverage or foodstuff precursor in the receptacle. A fluid supply system may also supply fluid to the receptacle. An example of such an arrangement is provided in WO 2014067987 A1.

In a sixth example, (which is not illustrated) the container processing unit is arranged as a dispensing and dissolution unit. The dispensing and dissolution unit is arranged to extract a single serving portion of beverage or foodstuff precursor from a storage portion of the machine (which can include any multi-portioned container including a packet or box). The dispensing and dissolution unit is arranged to mix the extracted single serving portion with the conditioned fluid from the fluid conditioning system, and to dispense the beverage or foodstuff into a receptacle. An example of such an arrangement is provided in EP14167344A.

### Second Example of Processing Unit

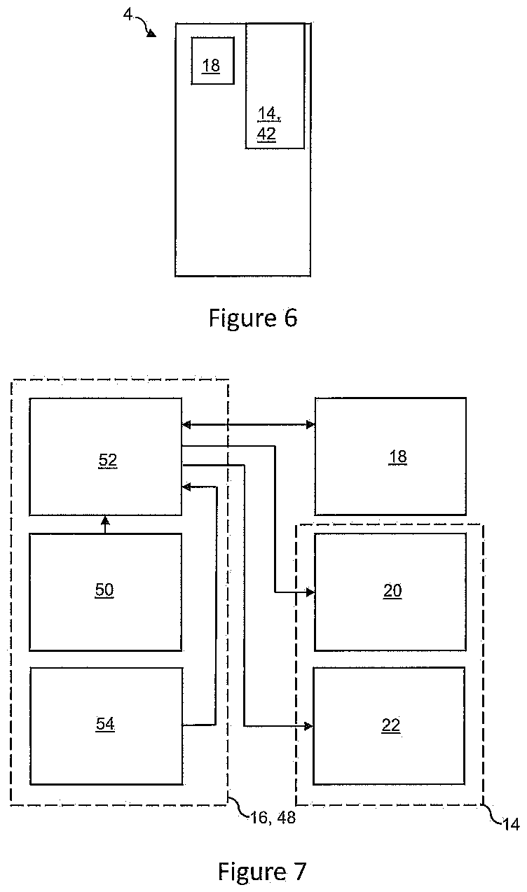

Referring to FIG. 6, in a second example of the processing unit 14, said unit comprises a comprises a loose material processing unit 42.

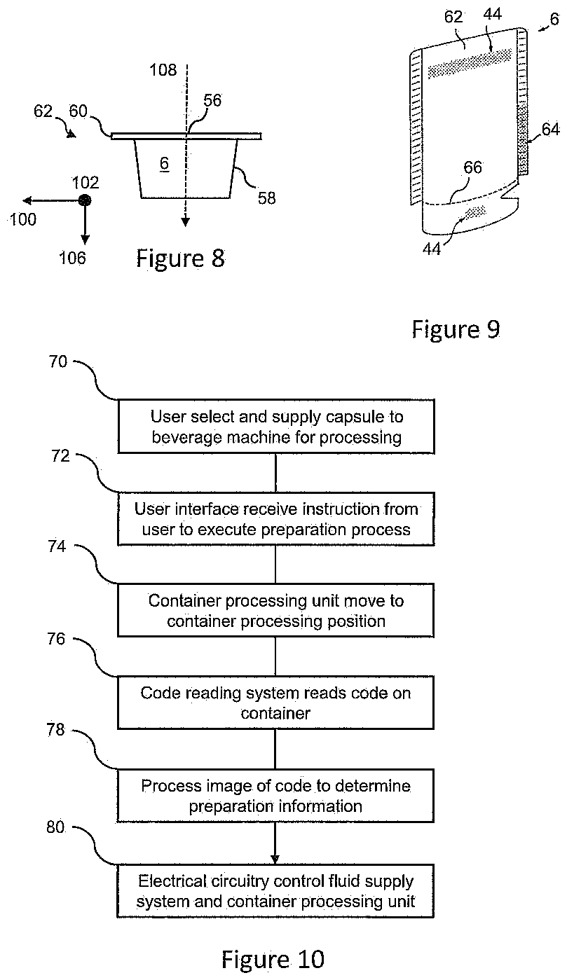

The loose material processing unit 42 is arranged to receive loose pre-precursor material from a container 6 (a suitable example is provided in FIG. 8 as will be discussed) and to process the pre-precursor material to derive the precursor material. The electrical circuitry 16 uses the preparation information read from the container 6 to control the loose material processing unit 42 to execute the preparation process.

A user resents manually the container 6 to a code reading system 18, of the machine 4, to read the code (as will be discussed). The user then opens the container 6 and dispenses the pre-precursor material (not illustrated) arranged therein into the loose material processing unit 42. The loose material processing unit 42 processes the loose pre-precursor material to the precursor material.

In a particular example, the pre-precursor material is coffee beans, and the loose material processing unit 42 is arranged to roast and/or grind the coffee beans to provide a precursor material.

In variant embodiments, which are not illustrated, the loose material processing unit is alternatively configured, including: with a dispensing system to open and dispense the pre-precursor from the capsule for subsequent processing (e.g. it may include a cutting tool to cut open the container and an extractor such as a scop to extract the pre-precursor material); the pre-precursor material may be processed in the container and either dispensed from the container by the aforedescribed example or provided to a user in the container.

### [Code Reading System]

Referring to FIGS. 4 and 5, the code reading system 18 is arranged to read a code 44 arranged on a lid of the container 6. The code reading system 18 is integrated with the extraction unit 32 of first example of the container processing unit 20. The code 44 is read with the extraction unit 32 in the capsule extraction position (as shown in FIG. 4).

The code reading system 18 includes a code reader 46 with an image capturing unit and a reading head housing the image capturing unit to capture a digital image of the code 44. Examples of a suitable image capturing unit include a Sonix SN9S102; Snap Sensor S2 imager; an oversampled binary image sensor; other like system.

The electrical circuitry 18 includes image processing circuitry (not illustrated) to identify the code in the digital image and extract preparation information. An example of the image processing circuitry is a Texas Instruments TMS320C5517 processor running a code processing program.

In variant embodiments, which are not illustrated, the code reading system is separate from the container processing unit including: it is arranged in a channel that the user places the container in and that conveys the container to the container processing unit; it is arranged to read a code on a receptacle, which is positioned to receive a beverage from an beverage outlet of a dispensing and dissolution unit. In further variant embodiments, which are not illustrated, the code reading system is arranged to read a code at a different location of the container, e.g. on a flange or containment portion. In further variant embodiments, which are not illustrated, the code is a one dimensional code and is read by relative movement between the code reader and the code to produce a code signal.

### [Control Electrical Circuitry]

Referring to FIG. 7, the electrical circuitry 16 is implemented as control electrical circuitry 48 to control the processing unit 14 to execute a preparation process. In the embodiment of FIG. 7, for illustrative purposes, the processing unit 14 is exemplified as the first example, which comprises a container processing unit 20 and a fluid supply unit 22.

The electrical circuitry 16, 48 at least partially implements (e.g. in combination with hardware) an: input unit 50 to receive an input from a user confirming that the machine 4 is to execute a preparation process; a processor 52 to receive the input from the input unit 50 and to provide a control output to the processing unit 14, and; a feedback system 54 to provide feedback from the processing unit 54 during the preparation process, which may be used to control the preparation process.

The input unit 50 is implemented as a user interface, which can include one or more of: buttons, e.g. a joystick button or press button; joystick; LEDs; graphic or character LDCs; graphical screen with touch sensing and/or screen edge buttons; other like device; a sensor to determine whether a container has been supplied to the machine by a user.

The feedback system 54 can implement one or more of the following or other feedback control based operations:
a flow sensor to determine a flow rate/volume of the fluid to the outlet 30 (shown in FIG. 3) of the fluid supply system 22, which may be used to meter the correct amount of fluid to the container 6 and thus regulate the power to the pump 26;
a temperature sensor to determine a temperature of the fluid to the outlet 30 of the fluid supply unit 22, which may be used to ensure the temperature of fluid to the container 6 is correct and thus regulate the power to the heat exchanger 28);
a level sensor to determine a level of fluid in the reservoir 24 as being sufficient for a preparation process;
a position sensor to determine a position of the extraction unit 32 (e.g. a capsule extraction position or a capsule receiving position).

It will be understood that the electrical circuitry 16, 44 is suitably adapted for the other examples of the processing unit 14, e.g.: for the second example of the container processing system the feedback system may be used to control speed of rotation of the capsule.

### [Container]

Referring to FIG. 8, a first example of a container 6, that is for use with the first example of the processing unit 14 comprises the container 6 arranged as a capsule 6. The capsule 6 includes a closing member 56 and a body portion 62, which comprises a storage portion 58, and a flange portion 60.

The storage portion 58 includes a cavity for storage of the precursor material (not illustrated). The cavity of the storage portion extends in a depth direction 106 from the flange portion 60. Referring to FIGS. 4 and 5, the storage portion 56 is perforated by the injection head 38 to supply conditioned fluid into the capsule.

The storage portion 58 is formed from a paper based material. The storage portion 58 has a thickness of 0.2 mm. The closing member 56 is formed from a paper based material. The closing member 58 has a thickness of 0.15 mm.

As used herein “paper based” may refer to as being formed at least partially from a thin sheet material produced by mechanically or chemically processing cellulose fibres derived from one or more of: wood; rags; grasses, or; other vegetable sources, in water, draining the water through fine mesh leaving the fibre evenly distributed on the surface, followed by pressing and drying.

The closing member 56 closes and may hermitically seal the storage portion 58 and comprises a flexible membrane. Referring to FIGS. 4 and 5, the closing member 56 is perorated to eject the beverage/foodstuff.

The flange portion 60 is formed integrally with the storage portion. The flange portion 60 is arranged at the junction of the storage portion 58 and closing member 56 and comprise a planar extension of the storage portion 58 that is overlapped by a portion of the closing member that is fixed thereto to hermetically seal the precursor material. The flange portion 60 extends in a plane defined by a lateral direction 102 and a longitudinal direction 100. Hence the closing member is planar in said plane.

The capsule 6 is circular cross sections such that it is rotationally symmetric about axis 108. In this way a user can present the capsule to the machine 2 with any orientation about the axis 108. The capsule 6 has a diameter of 53 mm, which is measured across an outer or inner periphery of the flange portion 60 in said plane of the flange portion 60. The capsule 6 can be configured with different sizes, which are characterised by different depths e.g.: 7 mm; 12 mm; 15 mm; 18 mm, and; 21 mm. The capsule 6 in each size is compatible with the first and second examples of the code reading system 18 as will be discussed.

In variant embodiments, which are not illustrated, the closing member may be arranged as convex or concave with respect to the storage portion. For example, for a convex arrangement, a centre of the closing member may extend into the storage portion in the depth direction by up to 1 mm±10% or 20%. A minimum concavity maybe 0.2 mm. For example, for a concave arrangement, a centre of the closing member may extend away from the storage portion in the counter depth direction by up to 4 mm±10% or 20%. A minimum concavity maybe 0.5 mm.

In variant embodiments, which are not illustrated: the body portion comprises the flange portion formed non-integrally with the storage portion and connected thereto; the body portion comprises the flange portion omitted, e.g. the closing member is wrapped around the storage portion; the container may be a non-rotationally symmetric shape, e.g. square sectioned or other shape; the capsule is alternatively dimensioned, including across an outer or inner periphery of the flange portion is 40-70 mm or 53 mm±10% or 20% and the depth is any of the described depths ±10% or 20%; the thickness of the storage portion may have a thickness of 0.1 to 0.4 mm or 0.2±20% or 30%; the thickness of the closing member may have a thickness of 0.05 to 0.3 mm or 0.15±20% or 30%, and; the storage portion and/or closing member may be made out of or include a different material, e.g. including a plastics or aluminium based material.

Referring to FIG. 9, a second example of a container 6 that is for use with the second example of the processing unit 14 comprises the container 6 arranged as a packet and includes: an arrangement of sheet material 62 joined at peripheral seams 64 defining an internal volume for the storage of the precursor material (not illustrated), and; an opening 66, that a user opens to dispense the precursor material into the loose material processing unit 42.

### [Arrangement of Code]

Referring to FIG. 8, the code 44 code may be arranged on an exterior surface of the container 6 in any suitable position such that it can be read by the code reading system 18.

In an first example, the code 44 is arranged at a central region of the closing member 56. The code can therefore be read by any code reader that is aligned to the centre of the container. In an second example, the code is reproduced over the entire closing member so that it can be read from any exterior position on the closing member 56. With such an arrangement the closing member does not require any specific alignment with the storage portion, which simplifies cutting and assembly processes for the container 6.

In variant embodiments, which are not illustrated, the code can be arranged on the flange portion 60 (including on either side) and on the storage portion 58. The code may also be arranged on the closing member but not on the central region.

In the second example shown in FIG. 9, the code 44 is arranged at various positions on the sheet material 62, including distal the seams 64.

### [Preparation Process]

Referring to FIG. 10, a process for preparing a beverage/foodstuff from precursor material is illustrated:

Block 70: a user supplies a container 6 to the machine 4.

Block 72: the electrical circuitry 16 (e.g. the input unit 50 thereof) receives a user instruction to prepare a beverage/foodstuff from precursor, and the electrical circuitry 16 (e.g. the processor 52) initiates the process.

Block 74: the electrical circuitry 16 controls the processing unit 14 to process the container (e.g. in the first example of the container processing unit 20, the extraction unit 32 is moved from the capsule receiving position (FIG. 4) to the capsule extraction position (FIG. 5)).

Block 76: the electrical circuitry 16 controls the code reading system 18 to provide a digital image of the code 6 of the container.

Block 78: the code processing circuitry of the electrical circuitry 16 processes the digital image to extract the preparation information.

Block 80: the electrical circuitry 16, based on the preparation information, executes the preparation process by controlling the processing unit 14. In the first example of the processing unit this comprises: controlling the fluid conditioning system 22 to supply fluid at a temperature, pressure, and time duration specified in the preparation information to the container processing unit 20.

The electrical circuitry 16 subsequently controls the container processing unit 20 to move from the capsule extraction portion through the capsule ejection position to eject the container 6 and back to the capsule receiving position.

In variant embodiments, which are not illustrated: the above blocks can be executed in a different order, e.g. block 72 before block 70 or block 76 before block 74; some block can be omitted, e.g. where a machine stores a magazine of capsules block 70 can be omitted.

Blocks 76 and 78 may be referred to a code reading and processing process. Block 80 may be referred to as the preparation process. The electrical circuitry 16, includes instructions, e.g. as program code, for the preparation process (or a plurality thereof). In an embodiment the processor 52 implements the instructions stored on a memory (not illustrated).

As part of the preparation process, the electrical circuitry 16 can obtain additional preparation information via the computer network 12 from the server system 8 and/or peripheral device 10 using a communication interface (not illustrated) of the machine.

### [Code General Description]

Referring to FIG. 11, the code 44 is formed of a plurality of circular units 80 arranged on a surround 82. The units 80 are a dark colour (e.g. including one of the following: black, dark blue, purple, dark green) and the surround 82 is a comparatively light colour (e.g. including one of the following: white, light blue, yellow, light green) such that there is sufficient contrast for the image capturing unit 46 to distinguish therebetween. The units 80 of the code may be configured to be read in the infra red and/or visible wavebands.

The units 80 are circular in shape. As used herein the term “shape” in respect of the units may refer to an exact shape or an approximation of the actual shape, which can occur to a printing or other manufacturing variations in precision.

In variant embodiments, which are not illustrated: the units are a light colour and the surround is a dark colour; the units have a different shape including one or a combination of the following shapes, triangular, polygon, in particular a quadrilateral such as square or parallelogram; other suitable shape.

The units 80 typically have a unit length of 50-200 μm. As used herein the term “unit length” in respect of a unit 80 may refer to a suitably defined distance of the unit 80, e.g.: for a circular shape the diameter; for a square a side length; for a polygon a distance between opposing or adjacent vertices; for a triangle a hypotenuse. The units 80 are arranged with a precision of about 1 μm.

The units 80 are formed by printing e.g. by means of an ink printer. As an example of printing the ink may be conventional printer ink and the substrate may be: polyethylene terephthalate (PET); aluminium coated with a lacquer (as found on Nespresso Classic capsules) or other suitable substrate.

In variant embodiments, which are not illustrated: the units are alternatively formed, including by embossing, engraving or other suitable means, and; the units are alternatively dimensioned, e.g. a unit length of 80-120 μm.

Referring further to FIG. 11, the units 80 are organised into: a reference portion R to locate and determine an orientation of the code 44, and; a data portion D to store the preparation information.

The units 80 of the code 44, which are arranged as the reference portion R, comprise three reference units 84. The reference units 84 have a unique spatial arrangement in the code 44 to allow the reference portion R to be identified by the electrical circuitry 16 (e.g. with a stored relationship on a memory thereof) in the digital image. The unique spatial arrangement comprises the reference units 84 arrange at three of the vertices of a virtual rectangle (not illustrated), about an origin O at the centre of the rectangle, with specific distances between the reference units 84.

In variant embodiments, which are not illustrated, the reference portion is alternatively implemented, including: as a different arrangement of reference units, e.g. including as a circle or other shape of rectangle; with a different number of reference units, e.g. including as 4 or 5, and; the reference units may have a unique shape that is identifiable from the shape of the other units forming the code.

The arrangement of the reference units 84 enables the definition of a single reference line r at a specific vector relative to said units 84. The reference line r is virtual, and is determined by the electrical circuitry 16 (e.g. with a stored relationship on a memory thereof).

In the particular example, the reference units 84 define, using the right hand rule, a first virtual line (not illustrated) and a second virtual line (not illustrated), wherein: the thumb represents the first virtual line which intersects the centres of two of the refence units 84; the index finger represents the second virtual line which intersects the centres of two of the refence units, one of which being the common to the first virtual line; the second finger is into the plane of the page of the code 44. The reference line r extends from the origin O and is parallel to the first virtual line and is orthogonal to the second virtual line.

In variant embodiments, which are not illustrated, the reference line may be alternatively defined: the may comprise an actual line drawn on the code; it may have an alternative geometric arrangement with respect to the reference units.

Units 80 of the code 44, which are arranged as the data portion D, comprise data units 86. The data units 86 are arranged on an encoding line E that intersects the reference line r. The encoding line E is virtual and is determined by electrical circuitry 16, (e.g. the encoding lines have predefined radii, which are stored on a memory thereof). The centre of the circle of the encoding line E is arranged at the origin O of the reference portion R. The reference line r therefore intersects the encoding line E with a tangent thereto orthogonal to the reference line r. There are two encoding lines E1, E2, each with data units 86.

In variant embodiments, which are not illustrated: other numbers of encoding lines are implemented including 3, 4, or 5; the encoding lines may have non-circular shapes, including rectangular or triangular; the encoding line comprises an actual line drawn on the code.

The encoding line E includes one or more individual data portions, each of which includes a start position 88 and a data unit 86, which is arranged at a distance d along the encoding line E from the start position 88 as a variable to encode a parameter of the preparation information. The start positions 88 are defined virtually and may be determined by electrical circuitry 16 (e.g. the start positions may be stored on a memory thereof). The individual data portions may also include an end position (not illustrated), which defines a maximum allowable distance d of the data unit 80 along the encoding line E from the start position 88. Both the start and end positions are formed virtually.

For the first encoding line E1, the data portion includes two individual data portions: for the first individual data portion the distance d can be any continuous distance from the start position 88 at the reference line r to the first data unit 86 clockwise from the reference line r; for the second individual data portion the distance d can be any continuous distance from the start position 88 at the data unit 86 of the first individual data portion (hence the start position is variable) to the mid-point m between the subsequent two data units 86 in the clockwise direction.

For the second encoding line E2, the data portion includes one individual data portion, for which the distance d can be any one of a plurality of discrete distances, which are illustrated as discrete positions 90 from the start position 88 at the reference line r, with each position associated with a value of the parameter. In the example there are 10 discrete positions 90.

A incremented distance can be defined as the distance between the start position 88 and an end position divided by the total number of positions (which is 10 for E2) in the data portion D that the data unit 86 may occupy.

In variant embodiments, which are not illustrated: a start position can be arranged at any position on the encoding line, including spaced away from the reference line; there may be multiple start positions on an encoding line, each with an associated data unit; the start position may be formed as part of the code as a unit rather than defined virtually; an encoding line may comprise combinations of parameters encoded by the continuous distance and the discreet positions; more than one or two data units on the encoding line may define the parameter, which can be determined as an average of the positions, and; the data portion can include any suitable number of individual data portions.

The code 44 includes an outer periphery 92 that the units 80 are arranged within. The outer periphery 92 is rectangular in shape and has a dimension of 600-1600 μm, or about 1100 μm. The code 44 may be repeated such that multiple repetitions of the code 44 are arranged within a single digital image, such that one or several best captured repetitions of the code can be selected for processing.

In variant embodiments, which are not illustrated: the outer periphery may be alternatively shaped, including circular; the outer periphery may have alternative sizes, including greater or smaller than the example range. In variant embodiments, which are not illustrated, the data portion alternatively encodes the value of said parameter, including as alphanumeric symbols or other arrangement.

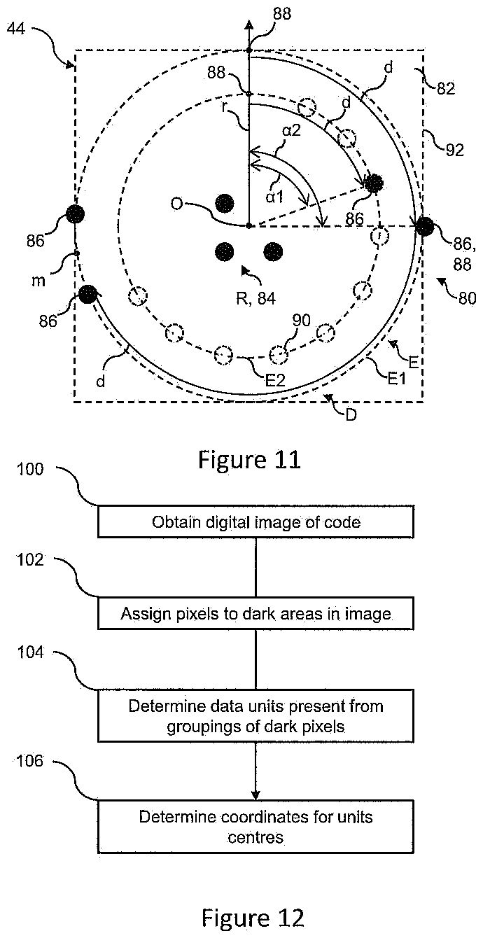

Referring to FIG. 12, with reference to the code of FIG. 11, a code processing process, which is executed by the electrical circuitry 16 (or the code processing circuitry thereof) for extraction of the preparation information includes:

### Step 1—Identify Locations of Units of Code

Block 100: obtain digital image of code 44 via the code reading system 118.

Block 102: assign pixels to dark areas in digital image that could represent units 80.

Block 104: if several pixels grouped in proximity of each other then determine a unit 80 as present.

Block 106: for each determined unit determine a centre of pixel grouping by a rule, e.g. feature extraction, to determine a coordinate of a centre of the unit.

Invariant embodiments, which are not illustrated, alternative processing techniques for determining units and there coordinates may be implemented, including other techniques for locating a centre of a unit or identifying a unit as present, e.g. a level of magnification may be implemented so that a single pixel is determined as a unit, and a centre of a unit may be determined as the centre of a pixel.

### Step 2—Locate Reference Portion and Read Angles of Code

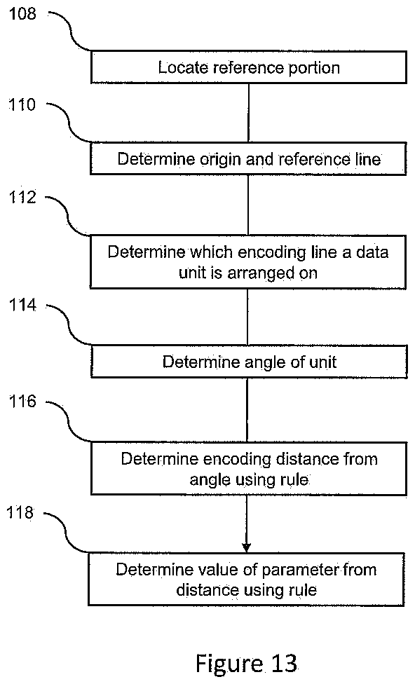

Referring to FIG. 13, with reference to the code of FIG. 11, processing of the code 44 includes:

Block 108: locate reference portion R by searching coordinates of units 80 of code 44 to identify the unique separation and geometric arrangement of reference units 84. This may be implemented by geometric rules including Pythagoras and trigonometry or other suitable rule. Said separation and geometric arrangement can be stored on the electrical circuitry 16 and accessed during searching.

Block 110: for the located reference portion R, define the origin O and the position of reference line r using a stored relationship. The arrangement of the origin and reference line can be stored on the electrical circuitry 16 and mapped onto the coordinates of the located reference portion.

Block 112: for each unit (other than the units of the reference portion) determine based on distance from the origin O which encoding line E the units belong to. The electrical circuitry 16 can store a radii range for each encoding line E and using geometric rules determine the distance of each unit from the origin O and which radii range it falls in.

Block 114: for each unit (other than the units of the reference portion) determine the angle α1, α2 with respect to the reference line r. It is to be noted that the angle is representative of the circumferential distance, and either could be used interchangeably. The angle can be calculated via know geometric relations between the coordinates of the reference line r and a virtual line extending from the origin O and through the associated unit.

### Step 3—Determine Values of Parameters of Preparation Information.

Referring to FIG. 13, with reference to the code of FIG. 11 processing of the code 44 includes:

Block 116: the encoding distance d is determined for each individual data portion. This is achieved by implementing a set of rules for determining the encoding distance d which are stored by the electrical circuitry 16. This can include the one or more of: the number of individual data portions on each encoding line; the start positions 88 of the individual data portions; if a single unit or multiple units represent a data unit 86, and; other suitable relationships.

For example referring to FIG. 9, the rules for determining the encoding distances d of encoding line E1 include that there are: two individual data portions; the start position 88 of the first individual data portion is at the intersection between the reference line r and the encoding line E1; the start position 88 of the second individual data portion is at the data unit 86 of the first individual data portion; the data unit 86 is of the first individual data portion is represented as a single unit of the code 44; the data unit 86 is of the second individual data portion is represented as a two units of the code 44.

For example referring to FIG. 11, the rules for determining the encoding distance d of encoding line E2 include that there is: a single individual data portion; the start position 88 is at the intersection between the reference line r and the encoding line E2; the data unit 86 is of the first individual data portion is represented as a single unit of the code 44.

Block 118: the encoding distances d for each data portion are converted into a value of a parameter. This is achieved by implementing a set of rules for converting the distance of a value which are stored by the electrical circuitry 16.

For example, for encoding line E1: the first individual data portion may encode a water volume of a brewing process wherein the distance d is any continuous value which is linearly related to the water volume, and; the second individual data portion may encode a time of a brewing process wherein the encoding distance d is any continuous value which is exponentially related to the time.

For example, for encoding line E2: the single individual data portion may encode a water temperature of a brewing process wherein the encoding distance d is a discrete value which incrementally changes by 5 degrees C. for each discrete position 90, and the rule specifies which 5 degree increment is closest to the determined encoding distance d.

In variant embodiments, which are not illustrated, other rules can be implemented, including: other mathematical functions relating the encoding distance to the value of the parameter, and; if an encoding distance is the average of the distance several individual data portions, and other suitable relationships.

### [Code Identifying Portion]

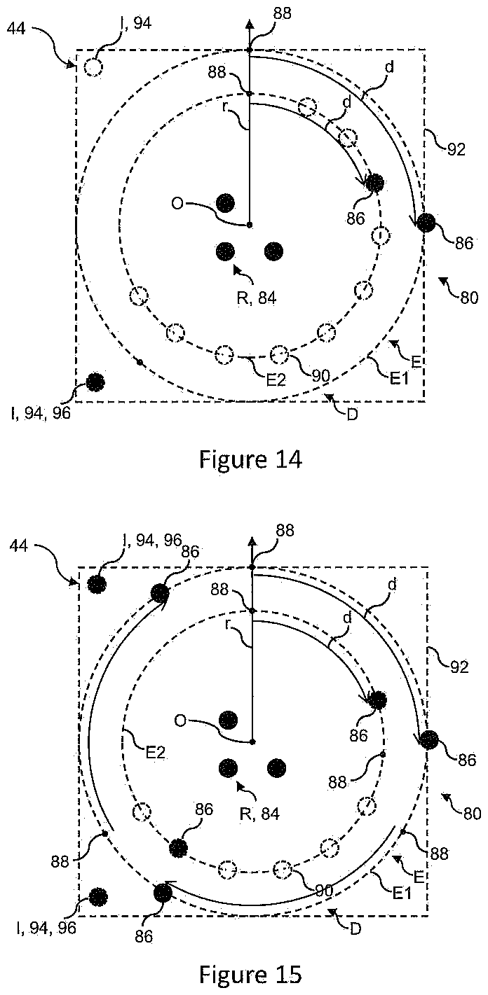

Referring to FIGS. 14, 15 and 16, the code 44 includes a code identifying portion I, which encodes information related to the encoding of the data portion D, e.g. the geometric arrangement of the data portion D. The following embodiment codes 44 can incorporate any feature of the preceding embodiments codes 44, e.g. those associated with FIGS. 11 to 13.

The code identifying portion I is arranged as discrete positions 94, which are arranged at predefined locations relative the reference portion R. The predefined locations can be stored on the electrical circuitry 16. The discrete positions 94 are distal the encoding lines E and proximal the outer periphery 92 of the code 44. There are first and second discrete positions 94 arranged at adjacent vertices of the code 44.

The discrete positions 94 either comprise or are absent an identifying unit 96 to encode information related to the encoding of the data portion D (e.g. the geometric arrangement of the data portion D). There are two discrete positions 94, hence the discrete positions 100 can encode four different variations of the data portion D, each of which are stored by the electrical circuitry 16 and can be looked up based on a value of the discrete positions 94.

In variant embodiments, which are not illustrated, the code identifying portion I comprises: additional discrete positions, e.g. 3 to 10 positions, for more complex encoding of the data portion; the discrete positions are alternately arranged, including on an encoding line or proximal the reference portion. The code may also be implemented as a bit code or other formulation with a reference portion data portion and code identifying portion.

In a first geometric variation shown in FIG. 14, the information of the code identifying potion I comprises: the lower discrete position 94 with an identifying unit 96, and the upper discrete position 94 absent a unit. The electrical circuitry 16 is implemented to look up via a stored relationship the arrangement of the data portion D related to this encoding pattern.

The associated first geometric arrangement of the of the data portion D comprises: a first encoding line E1 arranged with a single individual data portion with a continuous distance d encoded by a data unit 86 with a start position 88 at the reference line r, and; a second encoding line E2 arranged with a single individual data portion with 10 discrete positions 90 encoded as discrete distances d from a start position 88 at the reference line r.

In a second geometric variation shown in FIG. 15, the information of the code identifying potion I comprises: the lower discrete position 94 with an identifying unit 96, and the upper discrete position 94 with an identifying unit 96.

The associated second geometric arrangement of the of the data portion D comprises: a first encoding line E1 arranged with three individual data portions, each with a continuous distance d encoded by a data unit 90, one with a start position 88 at the reference line r and the other two with start positions 88 at predetermined angles from the reference line r, and; a second encoding line E2 arranged with two individual data portions, one with a continuous encoding distance d encoded by a data unit 86 with a start position 88 at the reference line r, and the second with 6 discrete positions 90 encoded as discrete distances d from a start position 88 arranged at a predetermined angle from the reference line r.

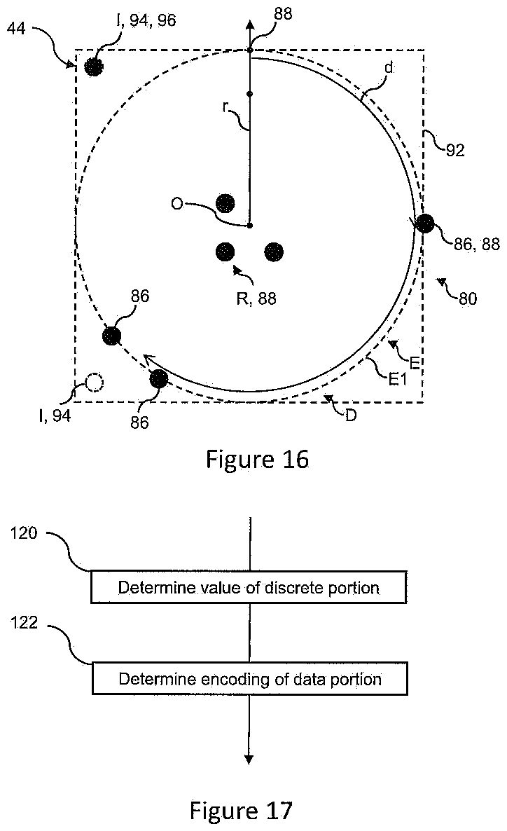

In a third geometric variation shown in FIG. 16, the information of the code identifying potion I comprises: the upper discrete position 94 with an identifying unit 96, and the lower discrete position 94 absent a unit.

The associated third geometric variation of the data portion D comprises: a single encoding line E1 arranged with two individual data portions, each with a continuous encoding distance d encoded by a data unit 86, the first individual data portion with a start position 88 at the reference line r and the second individual data portion with a start position 88 at the data unit 86 of the first individual data portion.

In a fourth geometric variation (not illustrated) an encoding pattern of the code identifying portion comprises the upper discrete position absent a unit, and the lower discrete position absent a unit. This encoding pattern relates to a geometric variation which may be any combination or other variant of the first to third variations. Indeed the fourth geometric variation may be undefined allowing for expansion of the code as the system is developed to include enhanced user functionality.

From the above examples, it can be understood that the code identifying portion I encodes information related to one or more of the following geometric arrangements of the data portion: how many individual data portions are arranged on an encoding line; how many encoding lines there are; the location of the individual data portions on an encoding line; a location of the start position of an individual data portion; a location of the end position of an individual data portion; an incremented distance and/or a number of increments between the start and end position that the data unit may be arranged within.

It will be understood that any of the aforesaid variables may be fixed, e.g. it is not encoded by the code identifying portion I, with one or more other variables encoded. For example, the number of encoding lines may be fixed and with their geometry fixed as circular, with the orientation of each encoding line fixed relative the reference portion, whereby the code identifying portion I encodes for each encoding line the number of data portions and their start positions.

As discussed, the electrical circuitry 16 implements on an electronic memory (not illustrated), a stored relationship between the encoding of the data portion D and the information read from the code identifying portion I. In the example above, the code identifying portion I acts as an identifier, with a predefined encoding of the code for each value of the identifier stored on the electrical circuitry 16 (e.g. via an electronic memory thereof).

As will be understood from the examples, the code identifying portion I may be related to other features of the encoding of the data portion D instead of or as well as its geometric arrangement.

In a first example, the code identifying portion I encodes information related to a representation of a data unit, wherein said representation comprises whether an encoding distance is defined by one or more data units. A single unit 86 is implemented for the individual data portions in the examples of FIGS. 14 and 15; two units 86 with an effective coordinate of the data unit being the mid-point therebetween is implemented for the second individual data portion in the example of FIG. 16.

In a second example, the code identifying portion I encodes information related to a type of data encoded by the data portion D, e.g. temperature or pressure etc. The type can refer to which parameter is associated with which of the individual data portions, e.g. in what order on an encoding line and one which encoding line.

In a third example, the code identifying portion I encodes information related to the data unit 86 being continuous or at discrete positions on the encoding line E. As an example, in FIG. 14: the encoding line E2 encodes the individual data portion as discrete positions 90, and; the encoding line E1 encodes the individual data portion continuously, such that it can occupy any encoding distance d from the start position 88 up to the end position.

In a fourth example, the code identifying portion I encodes information related to a rule for decoding the encoded preparation information, e.g. an equation that has as an input the encoding distance and an output as a value of a parameter (and not just parameters used in the equation).

Referring to FIG. 17, with reference to the code 44 of FIGS. 14 to 16, a modified a code processing process for processing codes 44 with a code identifying portion I is illustrated. The method is executed by the electrical circuitry 16 as part of the system 2 described for the preceding embodiments (including the various embodiments thereof).

The modified process includes Blocks 120 and Block 122, which are inserted between Block 110 and Block 112.

Block 120: the code identifying portion I is read based on the known position of the reference portion (R) (as identified at Blocks 108, 110). In the above examples, this comprises reading the discrete positions 94 to determine the identifier encoded by the information of the code identifying portion I.

Block 122: determine the encoding of the data portion D associated with the identifier of the code identifying portion I, (e.g. via a key-value database paradigm from an electronic memory stored on the machine 4, or distributed as part of the system 2). The encoding can include the geometric arrangement of the data portion D or any of the other first to fourth examples provided.

Block 116: is modified and includes determining the encoding distances d of the individual data portions from the angle using the determined encoding from Block 122. This step is as described for Block 116 of FIG. 13.

Block 118: is then executed is as described for of FIG. 13 to determine the values of the parameters encoded by the individual data portions.

Whilst the code is illustrated herein as being arranged on the container (e.g. on the lid portion), it will be appreciated that the code can be formed integrally on the container or formed on a separate substrate (not illustrated) which can be attached to; the container, or; to the machine, e.g., as a tab for arrangement between the container and the code reader so that the existing code reading arrangement may be used, or; other component, e.g. including a hand held component that is arranged for a user to present to a code reader of the machine, which may be suitably arranged for manual code reading.

It will be appreciated that any of the disclosed methods (or corresponding apparatuses, programs, data carriers, etc.) may be carried out by either a host or client, depending on the specific implementation (i.e. the disclosed methods/apparatuses are a form of communication(s), and as such, may be carried out from either ‘point of view’, i.e. in corresponding to each other fashion). Furthermore, it will be understood that the terms “receiving” and “transmitting” encompass “inputting” and “outputting” and are not limited to an RF context of transmitting and receiving radio waves. Therefore, for example, a chip or other device or component for realizing embodiments could generate data for output to another chip, device or component, or have as an input data from another chip, device or component, and such an output or input could be referred to as “transmit” and “receive” including gerund forms, that is, “transmitting” and “receiving”, as well as such “transmitting” and “receiving” within an RF context.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

As used herein, any machine executable instructions, or compute readable media, may carry out a disclosed method, and may therefore be used synonymously with the term method, or each other.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

LIST OF REFERENCES

2 System
4 Machine
14 Processing unit
20 Container processing unit (first example)
32 Extraction unit
34 Capsule holding portion
36 Closing portion
38 Injection head
40 Beverage outlet
22 Fluid conditioning system
24 Reservoir
26 Pump
28 Heat exchanger
30 Outlet
42 Loose material processing unit (second example)
16 Electrical circuitry
48 Control electrical circuitry
50 Input unit
52 Processor
54 Feedback system
18 Code reading system
46 Image capturing unit
6 Container
Capsule - Example 1
56 Lid portion
44 Code
80 Units
R Reference portion
84 Reference units
r Reference line
O Origin
D Data portion
86 Data units
E Encoding line
d Distance
88 Start position
90 Discrete positions
I Code Identifying portion
94 Discrete position
96 Identifying units
82 Surround
92 Outer periphery
58 Containment portion
60 Flange portion
Packet - Example 2
62 Sheet material
64 Seams
68 Opening
8 Server system
10 Peripheral device
12 Computer network

1: A container for containing a precursor material for use with a machine for preparing a beverage and/or foodstuff or a precursor thereof, the container including a machine-readable code storing preparation information for use with a preparation process performed by the machine, the code comprising:
a reference portion (R) to locate the code;
a data portion (D) to store the preparation information; and
a code identifying portion (I), wherein the code identifying portion (I) is separate from the reference portion (R), and
wherein the code identifying portion (I) encodes information related to a geometric arrangement of the data portion (D) relative the reference portion (R).

2: The container of claim 1, wherein the data portion (D) at least partially encodes a value of a parameter of the preparation information as a geometric distance (d) of a data unit of the code along a virtual encoding line (E) from a start position arranged on the virtual encoding line (E), with an end position arranged on the virtual encoding line (E) defining a maximum allowable distance (d),
and the geometric arrangement of the data portion (D) related to the information encoded by the code identifying portion (I) includes one or more of:
a location of the start position on the virtual encoding line (E);
a location of the end position on the virtual encoding line (E); and
an incremented distance and/or a number of increments between the start position and the end position that the data unit may be arranged within.

3: The container of claim 2, wherein the data portion is arranged as a plurality of individual data portions (D), each arranged on the virtual encoding line (E), identifying portion (I) comprises a number of individual data portions (D) on the virtual encoding line (E).

4: The container of claim 3, comprising a plurality of virtual encoding lines (E), and the data portion (D) is arranged as one or more individual data portions on each of the plurality of the virtual encoding lines (E),
and the geometric arrangement related to the information encoded by the code identifying portion (I) includes comprises a number of data portions (D) for each of the plurality of virtual encoding lines (E).

5: The container of claim 2, wherein the reference portion (R) is arranged to define a linear virtual reference line (L), and the virtual encoding line (E) is circular and is arranged to intersect the linear virtual reference line (L) at an intersection point,
wherein the location of the start position and/or the end position relative the intersection point is related to the information encoded by the code identifying portion (I).

6: The container of claim 2, wherein the code identifying portion (I) is arranged as one or more discrete positions arranged at a predefined location relative the reference portion (R),
the discrete positions either comprising or are absent a unit to encode the information as binary information related to the geometric arrangement of the data portion (D).

7: The container of claim 6, wherein the code identifying portion is arranged distal the virtual encoding line (E), with the virtual encoding line (E) arranged between the code identifying portion (I) and the reference portion (R).

8: The container of claim 2, wherein the code identifying portion (I) encodes information related to a representation of the data unit, wherein the representation identifies whether an encoding distance is defined by one or more data units.

9: The container of claim 2, wherein the code identifying portion (I) encodes information related to an encoding of the data unit being continuous or at discrete positions on the virtual encoding line (E).

10: The container of claim 1, wherein the code identifying portion (I) encodes information related to a type of data encoded by the data portion (D).

11: The container of claim 1, wherein the code identifying portion (I) encodes information related to a rule for decoding the preparation information stored by the code.

12: The container of claim 1, wherein the information encoded by the code identifying portion (I) comprises an identifier, which is for the machine to look-up the geometric arrangement of the data portion (D).

13: A substrate for attachment to (i) a container for containing a precursor material for use with a machine for preparing a beverage and/or foodstuff or a precursor thereof or (ii) a machine for preparing a beverage and/or foodstuff,
the substrate comprising a code comprising:
a reference portion (R) to locate the code;
a data portion (D) to store the preparation information; and
a code identifying portion (I), wherein the code identifying portion (I) is separate from the reference portion (R), and
wherein code identifying portion (I) encodes information related to the geometric arrangement of the data portion (D) relative the reference portion (R).

14: A machine for preparing a beverage and/or foodstuff or a precursor thereof, the machine including:
a code reading system to read a code of a container;
a processing unit for processing precursor material of the container; and
electrical circuitry to control the processing unit based on preparation information read from the code,
the electrical circuitry configured to execute steps of:
locating a reference portion (R) of the code;
reading a code identifying portion (I) of the code which is separate from the reference portion (R) and arranged relative the located reference portion (R) to determine a geometric arrangement of a data portion (D); and
reading the data portion (D) of the code based on the determined geometric arrangement to determine the preparation information from the data portion (D).

15: A system comprising:
(a) a container including a machine-readable code storing preparation information for a preparation process, the code comprising:
a reference portion (R) to locate the code;
a data portion (D) to store the preparation information; and
a code identifying portion (I), wherein the code identifying portion (I) is separate from the reference portion (R), and
wherein the code identifying portion (I) encodes information related to a geometric arrangement of the data portion (D) relative the reference portion (R); and
(b) a machine including:
a code reading system to read the code of the container;
a processing unit for processing precursor material of the container; and
electrical circuitry to control the processing unit based on the preparation information read from the code,
the electrical circuitry configured to execute steps of:
locating the reference portion (R) of the code;
reading the code identifying portion (I) of the code which is separate from the reference portion (R) and arranged relative the located reference portion (R) to determine the geometric arrangement of a data portion (D); and
reading the data portion (D) of the code based on the determined geometric arrangement to determine the preparation information from the data portion (D).

16. (canceled)

17: A method of encoding preparation information with a code,
the method comprising:
arranging a data portion of the code relative to a reference portion of the code; and
arranging a geometric arrangement of the data portion based on information encoded by a code identification portion of the code which is separate from the reference portion of the code.

18: A method of reading preparation information from a code for use in a preparation process, in which a machine is controlled based on the preparation information to prepare a beverage and/or foodstuff or precursor thereof, the method comprising:
locating a reference portion (R) of the code;
decoding a code identifying portion (I) of the code which is separate from the reference portion (R) of the code and arranged relative the located reference portion (R) to determine a geometric arrangement of a data portion (D);
reading the data portion (D) based on the determined geometric arrangement to determine the preparation information from the data portion (D).

19: The method of claim 18, wherein reading the code identifying portion (I) of the code to determine a geometric arrangement of the data portion (D) comprises:
obtaining information from the code identifying portion (I), and
determining the geometric arrangement of the data portion (D) based on a stored relationship between the information and the geometric arrangement.

20: The method of claim 18, the method comprising reading a code identifying portion (I) to determine one or more of:
a representation of a data unit, wherein the representation identifies whether an encoding distance is defined by one or more data units;
an encoding of the data unit being continuous or at discrete positions on an encoding line;
a type of data encoded by the data portion (D), and;
a rule for decoding the encoded preparation information.

21-23. (canceled)
